(19) United States
(12) Patent Application Publication
(10) Pub. No.: US 2005/0230980 A1
(43) Pub. Date: Oct. 20, 2005

(54) Wind turbine mounted on power transmission tower

(76) Inventor: Andre Brunet, Carlsbad Springs (CA)

Correspondence Address: Ruden, McClosky, Smith, Schuster & Russell, P.A., Suite #800, 222 Lakeview Avenue, West Palm Beach, FL, 33401-6112, US

(21) Appl. No.: 10/828,631

(22) Filed: Apr. 15, 2004

(51) Int. Cl. F03D 1/00; F03B 7/00; H02P 9/04

(52) U.S. Cl. 290/44

(57) ABSTRACT

A power transmission tower carrying power lines has a wind turbine mounted to an upper portion of the tower. The wind turbine has a rotor which drives a generator for generating electric power. The generated power is stepped up using a transformer before being fed into one of the power lines. Optionally, electric power generated by a plurality of such wind turbines could be accumulated downstream and then transformed and fed into the grid at multiple-tower intervals. The wind turbine can be mounted on a lattice tower, a monopole tower or a hybrid tower. The wind turbine has either a fixed horizontal axis or a variable (but non-vertical) axis. Alternatively, a vertical-axis wind turbine may be used provided the generator is mounted at or near the top of the tower. Using existing infrastructure, the present invention supplements the capacity of a power grid with environmentally friendly power generation.

### CROSS-REFERENCE TO RELATED APPLICATIONS

This application claims the benefit of priority under 35 U.S.C. §119 from Canadian Patent Application serial number as yet unknown which was filed on Mar. 26, 2004 listing Andre Brunet as the inventor.

### TECHNICAL FIELD

The present invention relates generally to electric power generation and, in particular, to a wind turbine for a power transmission tower.

### BACKGROUND OF THE INVENTION

Wind turbines provide a clean and “environmentally friendly” alternative to generating electric power with coal-fired and nuclear plants. Wind turbines use rotor blades to harness wind power by converting the kinetic energy of the wind into rotational energy of a generator which in turn converts the rotational energy into electric power in a manner well known in the art.

The power extracted from the wind is proportional to the cube of the wind speed and therefore wind turbines are most effective where the average wind speed is high. In order to increase average wind speed, wind turbines are often mounted at higher elevations or atop towers, such as in the manner illustrated in the prior-art rendition shown in FIG. 1.

As illustrated in FIG. 1, a prior-art wind turbine 10 having three rotor blades 12 is mounted atop a supporting tower 14. A base 16 of the supporting tower 14 is anchored to the ground 8. Electric power generated by the wind turbine 10 is transformed by a transformer 20. The transformer is connected to the generator output of the wind turbine 10 by electric lines 22. Stepped-up power is then fed through power lines 24 which are carried by a power transmission tower 30. The power transmission tower 30 has a tower structure 32 which can be a lattice structure, a monopole structure (as shown) or a hybrid structure. The tower structure 32 is anchored at a base 34 to the ground 8. The tower structure 32 has supporting arms 36 for carrying the power lines 24 (also known as high-tension lines). A series of spaced-apart power transmission towers convey electric power from the wind turbine (or wind farm) through a power grid to a substation where it is stepped down and tapped off for end-user consumption. The transmission towers may constitute part of a power grid, as mentioned, or they may simply be part of an off-grid transmission line running from a wind farm to a power consumer such as a factory.

Although wind turbines are being used increasingly to generate clean power, large-scale wind power generation currently suffers from certain drawbacks in terms of land requirements, long distances from the grid, and tower installation costs which diminish the efficacy and cost-effectiveness of wind power generation.

Most small wind turbines are currently being used by individuals for rural households to go “off grid”. However, large-scale wind power generation requires a “wind farm” typically composed of a large number of wind turbines, which are usually large-scale turbines, although some wind farms are known to use a very small number of very large scale turbines. Because of the large number of wind turbines needed to generate a significant amount of electric power, these wind farms are known to occupy large tracts of land. The cost of purchasing or leasing land decreases the overall cost-effectiveness of wind power generation.

Furthermore, wind farms are typically located on the outskirts of towns and cities where large tracts of land are available and relatively inexpensive. Often, the location of the wind farm is such that it is far from the power grid; in that case, the power generated by the wind farm must be transmitted to the power grid. Even if the output of the wind farm is stepped up with step-up transformers to high voltages, some of the generated power is lost due to resistance in the transmission lines linking the wind farm and the power grid.

Another drawback of large-scale wind power generation is that the cost of installing a large number of wind turbines involves not only the cost of the wind turbine units themselves but also the installation cost of the supporting towers. The cost of installing towers is a very substantial part of the overall cost of building the wind farm.

Therefore, in view of these drawbacks, it would be highly desirable to provide an improved apparatus for wind power generation. PCT Application PCT/JPOO/04527 which was published as WO 01/90575 A1 on May 22, 2000 discloses a vertical-axis wind turbine such as a Darrieus turbine installed on an existing power transmission tower. The turbine's rotor blades are located at the top of the tower but its nacelle (that houses the electric generator) is located on the ground, thereby requiring a long vertical drive shaft running from the top of the tower to the base of the tower. The long vertical drive shaft is both costly and mechanically inefficient. Because vertical-axis wind turbines are generally less efficient and more costly to build than horizontal-axis wind turbines, their usage is fairly limited. Therefore, there remains a need for an apparatus for generating wind power using existing power grid infrastructure that is not only inexpensive but also efficient.

### SUMMARY OF THE INVENTION

It is therefore an object of the present invention to provide a power transmission tower with a wind turbine mounted thereto. The tower includes a generally vertical structure having a base anchored to the ground and a plurality of supporting arms for supporting power lines that transmit electrical power. The tower further includes a wind turbine having a rotor for driving a generator, the generator being connected to an upper portion of the transmission tower.

The present invention also provides a power transmission tower supporting one or more wind turbines. The tower includes a tower structure having a base anchored to the ground and supporting arms for supporting power lines for transmitting electrical power. The tower further includes at least one non-vertical-axis wind turbine connected to the transmission tower for generating electrical power for feeding into a power grid serviced by the tower.

The present invention further provides a wind turbine kit for mounting a wind turbine to a power transmission tower. The kit includes a non-vertical-axis wind turbine having a rotor for driving a generator and a connector for connecting the wind turbine to the tower.

By mounting wind turbines directly on top of power transmission towers, clean, “environmentally friendly” electricity can be generated without any substantial increase in power grid infrastructure. By implementing the present invention, clean electric power can be generated without having to buy or lease further tracts of land. The present invention also eliminates the cost of building and installing towers to support the wind turbines. As a collateral benefit, the visual and aesthetic impact on the environmental is minimized. Moreover, since the wind turbines are mounted on the transmission towers, the problem of distance to the power grid is resolved. In other words, due to the proximity of the wind turbine to the point where the generated power enters the power grid, the line losses are greatly reduced.

### BRIEF DESCRIPTION OF THE DRAWINGS

Further features and advantages of the present invention will become apparent from the following detailed description, taken in combination with the appended drawings, in which:

FIG. 1 is a wind turbine elevated above the ground by a supporting tower and hooked up to power lines carried by a power transmission tower in accordance with the prior art;

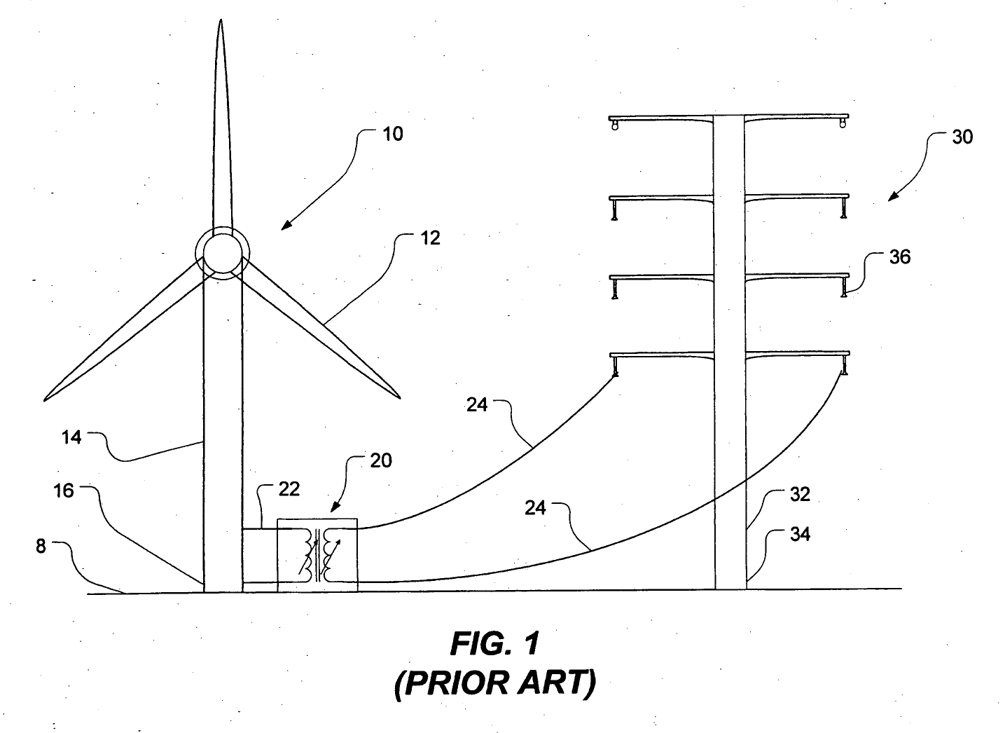

FIG. 2 is a schematic view of a wind turbine mounted on a lattice-type power transmission tower in accordance with an embodiment of the present invention;

FIG. 3 is a schematic view of a wind turbine mounted on a monopole power transmission tower in accordance with a second embodiment of the present invention;

FIG. 4 is a schematic view of a wind turbine mounted on a hybrid power transmission tower in accordance with a third embodiment of the present invention;

FIG. 5 is a schematic view of a wind turbine mounted on a monopole power transmission tower reinforced with guy wires in accordance with a fourth embodiment of the present invention;

FIG. 6 is a schematic view of a vertical-axis wind turbine mounted to a top of a lattice-type power transmission tower in accordance with a fifth embodiment of the present invention;

FIG. 7 is a schematic view of a variable-axis wind turbine mounted to a top of a lattice-type power transmission tower in accordance with a sixth embodiment of the present invention;

FIG. 8 is a schematic view of a lattice-type power transmission tower supporting two wind turbines in accordance with a seventh embodiment of the present invention; and

FIG. 9 is a schematic view of a series of five wind turbines mounted atop respective lattice-type power transmission towers in which wind-generated power is accumulated, transformed and fed into the power grid at every fifth tower.

It will be noted that throughout the appended drawings like features are identified by like reference numerals. Furthermore, being schematic, the figures are neither drawn to scale nor are the proportions of the various components necessarily accurate or representative of how large or small a wind turbine is to be in relation to a given tower.

### DETAILED DESCRIPTION OF PREFERRED EMBODIMENTS

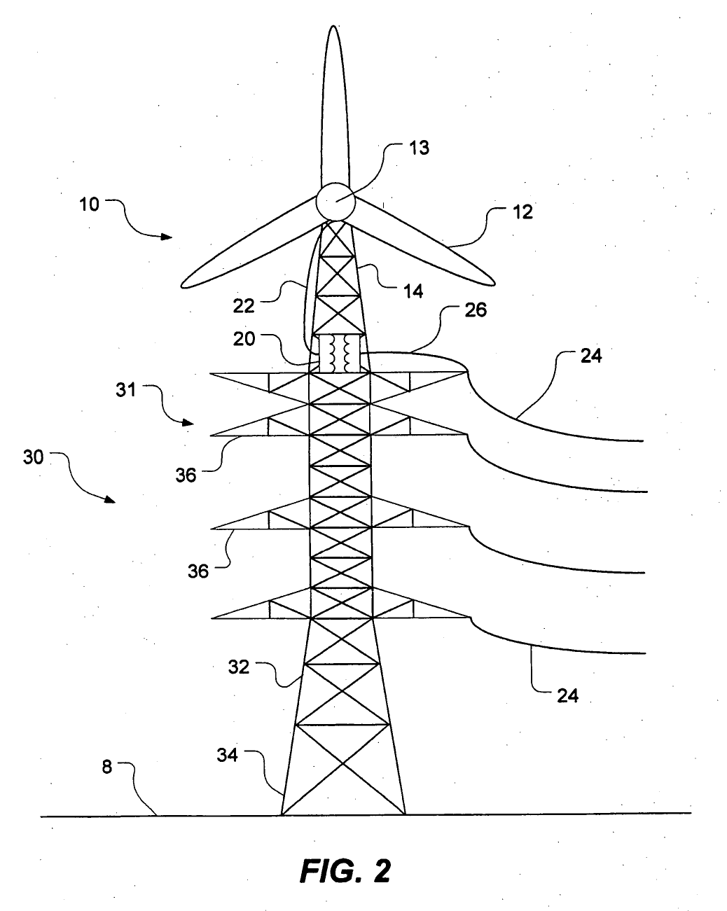

FIG. 2 shows a horizontal-axis wind turbine generally designated by reference numeral 10 mounted to a power transmission tower 30 in accordance with a first embodiment of the present invention. For the purposes of this specification, the expression “power transmission tower” includes any transmission tower, distribution tower, tower, pole or other structure capable of carrying electric power lines above ground.

As shown in FIG. 2, the horizontal-axis wind turbine 10 has three rotor blades 12 for driving an electric generator, which is housed within a nacelle 13. The generator is preferably horizontal-axis as well although its orientation may conceivably differ depending on the connection between the rotor and the generator. For the purposes of this specification, the expression “generator” means a generator, alternator or any other electricity-producing device capable of converting the kinetic energy of a rotor into electricity.

of course, the wind turbine may have a different number of rotor blades than the three illustrated. The rotor blades preferably have an airfoil shape and are made of a lightweight material such as fiberglass, although persons of skill in the art will appreciate that other materials and blade shapes may be substituted. In order to ensure sufficient clearance between the rotor blades 12 and the power lines carried by the tower, the wind turbine is typically mounted on a substructure or tower extension 14 which is connected to an upper portion of the power transmission tower 30. The tower extension 14 may be a lattice substructure, as shown, or a monopole or hybrid substructure.

As illustrated in FIG. 2, the power transmission tower generally designated by reference numeral 30 has a generally vertical structure 32, which shall also be referred to as a tower structure. The tower structure 32 is shown to be a lattice structure, although it could also be a monopole structure or a hybrid structure. The tower structure 32 has a base 34 anchored to the ground 8 and a plurality of supporting arms 36 for supporting power lines 24 that transmit electric power. In addition, the power transmission tower 30 may be used to support a transformer 20 as shown. Alternatively, the transformer 20 may be mounted to the tower extension 14 that supports the wind turbine 10, to the ground or to any other suitable location.

As shown in FIG. 2, the horizontal-axis wind turbine 10 is mounted preferably to the top of the power transmission tower 30 where average wind speeds tend to be greatest. However, the horizontal-axis wind turbine 10 need not be mounted to the top of the power transmission tower 30. The horizontal-axis wind turbine 10 may be mounted anywhere on the power transmission tower 30 provided the rotor blades 12 do not interfere with the power lines. Preferably, though, in order to benefit from higher average wind speeds, the wind turbine 10 should be mounted to the top of the power transmission tower 30 or at least to an upper portion 31 of the power transmission tower 30. Wind turbines are able to generate either AC or DC. If the wind turbine generates DC, a power inverter must be provided to convert the DC power to AC power before the generated power is fed into the power grid. Throughout the specification, it should be understood that the wind turbines can be either AC-generating or DC-generating and if the latter, then a power inverter is to be provided to convert the DC to AC. The type of wind turbine to be used (AC-generating or DC-generating) is a matter of design choice, and will depend on a variety of system parameters such as the efficiency of the turbine, its output voltage and the voltage carried in the power transmission line into which it feeds. Persons of ordinary skill in the art will further appreciate that in lieu of, or in addition to, a power inverter, it may be necessary or advantageous to provide a power converter, bridge rectifier or other device to ensure proper and efficient connection to the grid.

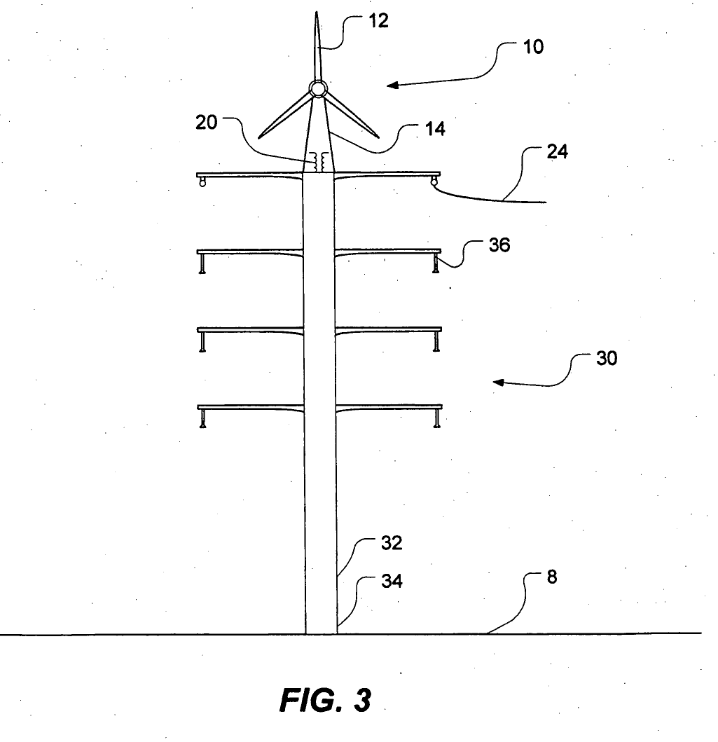

FIG. 3 shows a second embodiment of the present invention in which a horizontal-axis wind turbine 10 is mounted atop a monopole power transmission tower 30. The tower structure 32 of the monopole tower is typically tapered. The base 34 of the tower is anchored to the ground 8. The tower has a plurality of supporting arms 36 for suspending power lines. Connected to the top of the tower 30 is the wind turbine 10. The wind turbine is supported above the power lines by a substructure or tower extension 14 which, in this case is monopole although it could be lattice or hybrid. The transformer 20 is mounted either to the wind turbine or to the power transmission tower 30. Electric lines feed power that is generated by the wind turbine into the power lines 24. The wind turbine is shown to be a horizontal-axis wind turbine. This horizontal-axis wind turbine may be mounted anywhere on the power transmission tower provided it does not interfere with the power lines. However, the horizontal-axis wind turbine is preferably mounted at or near the top of the power transmission tower. Being connected to an upper portion of the power transmission tower, the wind turbine is able to harness higher average wind speeds.

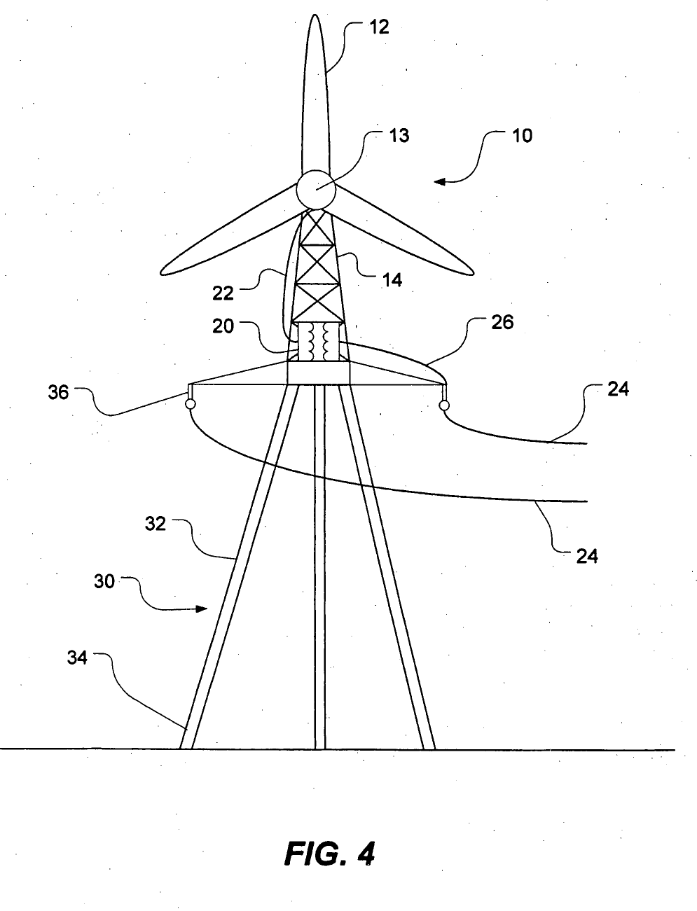

FIG. 4 depicts a third embodiment of the present invention in which a wind turbine 10 is mounted atop a power transmission tower 30 having a hybrid tower structure 32. Such towers are known as “hybrid” because they are a combination of lattice and monopole structures. In this case, the hybrid tower has three support legs, as shown. Mounted atop the hybrid power transmission tower 30 is a lattice substructure or tower extension 14 which supports a wind turbine 10. The substructure 14 could also be monopole or hybrid. The wind turbine 10 has a horizontal-axis generator housed within the nacelle 13. A transformer 20, mounted either to the tower extension 14 or to the power transmission tower 30, steps up the voltage being output from the wind turbine before being fed into the power lines carried by the supporting arms 36 of the power transmission tower 30.

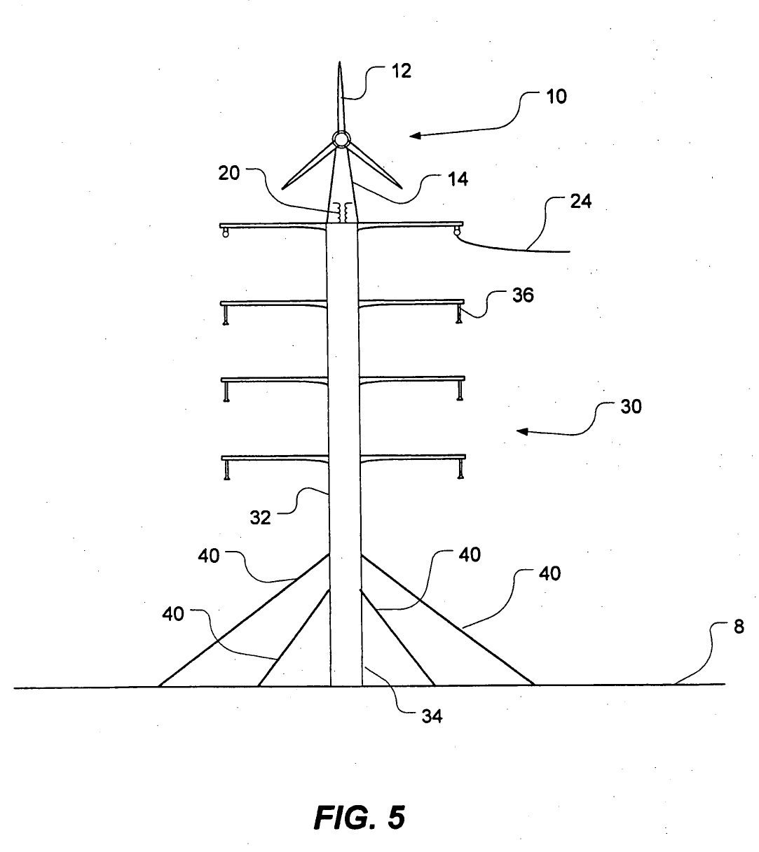

FIG. 5 illustrates a fourth embodiment of the present invention in which a wind turbine 10 is mounted to the top of a monopole power transmission tower 30 that is reinforced with guy wires 40. Guy wires are necessary to stabilize the power transmission tower where the projected worst-case lateral loads exceed the prescribed factor of safety for the tower structure.

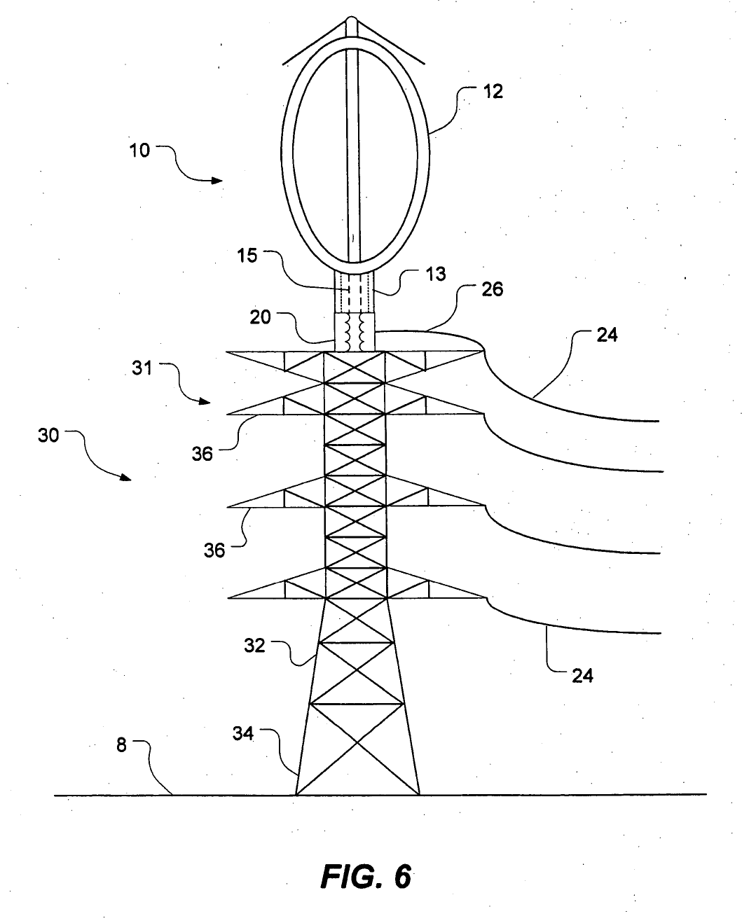

FIG. 6 shows a vertical-axis wind turbine 10 mounted to an upper portion 31 of the power transmission tower 30 in accordance with a fifth embodiment of the present invention. The wind turbine has a vertically oriented nacelle 13 housing a vertically oriented generator 15 at an upper portion of the tower. Due to the vertical orientation of the wind turbine, a tower extension might not be required. Vertical-axis wind turbines are generally one of two varieties: lift-type or drag-type. Examples of vertical-axis wind turbines that may be adapted for use on a power transmission tower include the stacked Savonius rotor, which is a drag-type device, and the Darrieus turbine, which is a lift-type machine. Other vertical-axis wind turbines which may be adapted are the giromill and the cycloturbine. For the embodiments of this invention where vertical-axis wind turbines are employed, the electric generator is mounted to the power transmission tower 30 at an upper portion 31 of the tower. For the purposes of this specification, the expression “upper portion” in reference to the tower shall mean that the wind turbine is mounted to the top half of the tower, i.e. above the midway point between the base and the top of the tower. Although a lattice structure is shown as the tower structure 32, persons of skill in the art will appreciate that a vertical-axis wind turbine may also be adapted for mounting to an upper portion of a monopole tower or a hybrid tower. Of course, guy wires might be required to stabilize the tower.

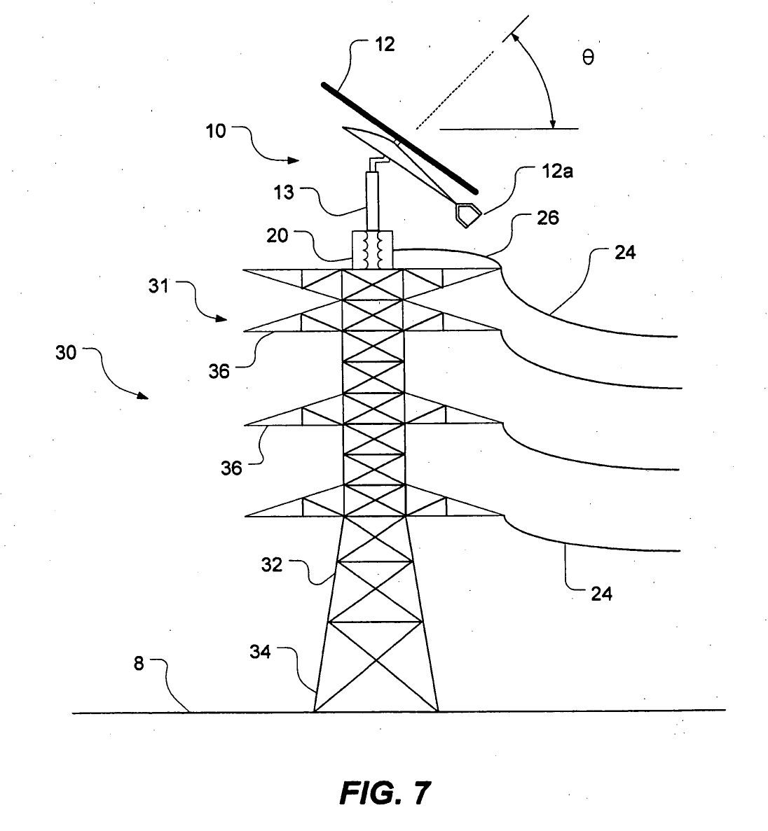

FIG. 7 depicts a sixth embodiment of the present invention in which a variable-axis wind turbine 10 is mounted to an upper portion 31 of the power transmission tower 30. The variable-axis wind turbine, which is known in the art, tilts from a horizontal posture to an oblique or nearly vertical posture when the wind speed exceeds a safety threshold. The variable-axis wind turbine has a lift tail 12a (or other such mechanism) permitting the turbine to adopt any tilt θ between the horizontal and the nearly vertical postures. By tilting its rotor and nacelle, the wind turbine reduces its rotor profile and wind exposure and thus diminishes the lateral wind load acting on the wind turbine and tower. This is particularly useful in areas that are prone to extremely high winds and stormy weather.

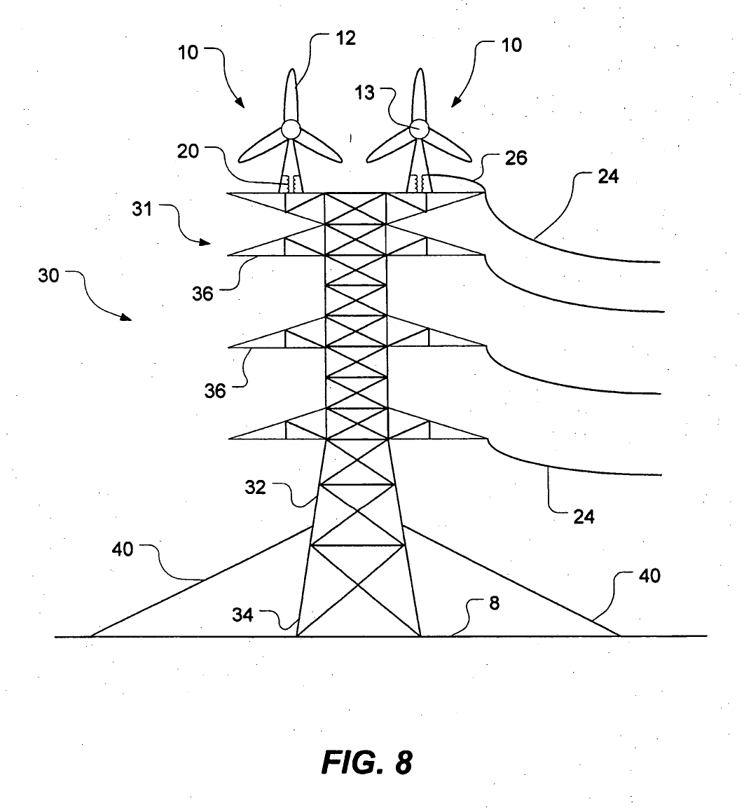

FIG. 8 illustrates a seventh embodiment of the present invention in which two wind turbines 10 are mounted to the top of a power transmission tower 30. Although only two wind turbines 10 are shown in FIG. 8, persons of ordinary skill in the art will appreciate that three or more wind turbines may be mounted to a power transmission tower provided the tower is able to safely accommodate the wind turbines. The maximum number of wind turbines that can be mounted to a power transmission tower is limited by the strength and stability of the tower and the spacing requirements, i.e. the spacing needed for the rotor blades to rotate without interfering with each other. Due to the extra load exerted on the power transmission tower, a multiple-turbine tower preferably employs a lattice tower structure 32 with guy wires 40, as illustrated, to provide greater stability.

Although FIG. 8 shows both wind turbines at the top of the power transmission tower, it is not necessary for both wind turbines 10 to be mounted in that manner. For instance, one of the wind turbines may be mounted at the top of the power transmission tower while the second may be mounted below the first wind turbine, at an upper portion thereof, provided it does not interfere with the power lines.

Furthermore, two or more vertical-axis or variable-axis wind turbines may be adapted for connection to the power transmission tower in lieu of horizontal-axis wind turbines. Persons of ordinary skill in the art will recognize that it is possible to adapt the power transmission tower to accommodate various combinations of horizontal, vertical and variable wind turbines.

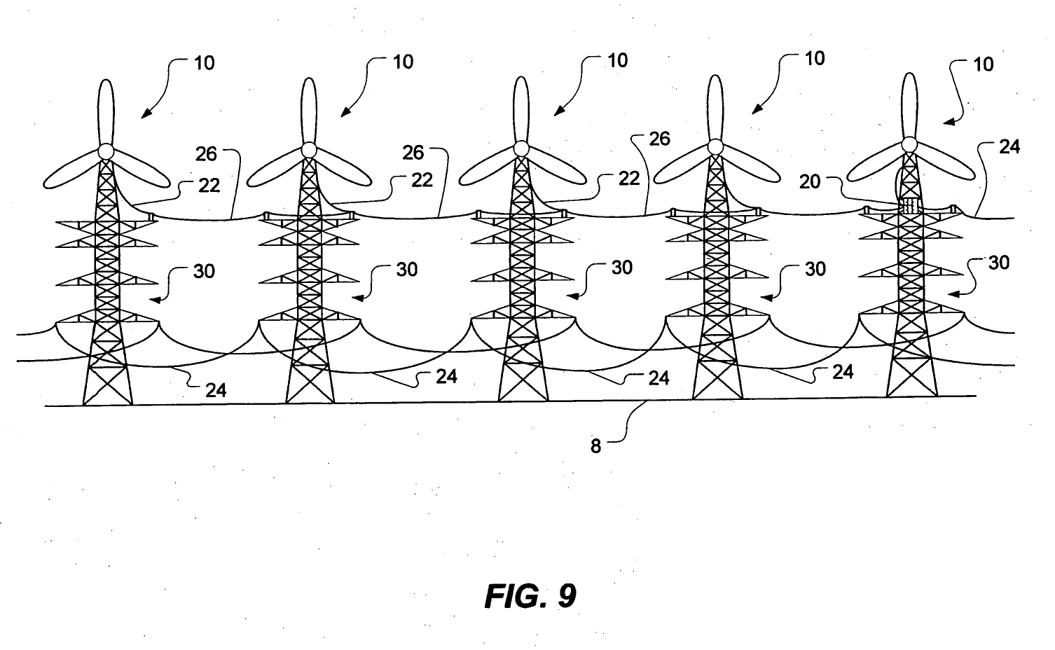

In operation, the wind turbines generate electric power that is approximately proportional to the cube of the wind speed minus mechanical and electrical losses in the turbine itself. The generated electric power is then transformed using one or more step-up transformers in a manner that is well known in the art. Power transmission towers typically carry high voltages because line losses are less at higher voltage. However, depending on the voltage output by the wind turbine and the voltage being carried by the power lines, it may be more advantageous to accumulate the generated current downstream, say at every five or ten towers, before transforming it into a high voltage for feeding into the grid. This technique is illustrated in FIG. 9 where a series of five power transmission towers, each with its own wind turbine mounted thereon, contributes electric current to an auxiliary line that spans the towers. Electric current is accumulated downstream and at the fifth tower the accumulated current is transformed using one or more step-up transformers.

As shown in FIG. 9, a wind turbine 10 is mounted to each of a series of five power transmission towers 30 in the manner already described. The power transmission towers 30 carry standard power lines 24 from supporting arms, as described earlier. Each wind turbine 10 generates electric power which is output onto electric lines 22 (only one line is shown schematically for the sake simplicity). The electric lines 22 transmit current through auxiliary lines 26. Electric current thus accumulates downstream. At the fifth power transmission tower, power is transformed using transformer 20 and then fed into the power lines 24. While the example illustrated in FIG. 9 utilizes five towers as the “accumulation interval”, persons of ordinary skill in the art will appreciate that the optimal accumulation interval is a matter of design choice that will vary depending on a variety of system parameters such as the turbine output voltage and the voltage carried in the power lines.

Wind turbines may be mounted to preexisting power transmission towers. These towers may be buttressed or reinforced with guy wires or other structural reinforcements. Alternatively, this invention may be applied to the installation of new power transmission towers, which may be designed to take the weight and lateral load of larger wind turbines.

The wind turbines described and illustrated in this specification may be utilized to generate electric power to supplement the available power in the power grid. Alternatively, a plurality of small wind turbines may be used to compensate for line losses in the spans between adjacent towers. In either case, the total power generated by a large number of these wind turbines would be quite substantial. For example, in the Province of Ontario alone, there are an estimated 47,000 towers. Assuming only 20,000 of these towers are used to support wind turbines, and assuming that each wind turbine is capable of generating an estimated 2000 kWh per month (or 24,000 kWh per year), then the total output would be about 500,000,000 kWh per year (or 500,000 MWh per year). Since the peak power consumption in Ontario is about 5000 MW, these wind turbines would contribute the equivalent of about 100 hours (or 4 days' worth) of peak consumption. Since average power consumption is in fact quite a bit less, these wind turbines might be able to contribute the equivalent of about one week of power, which means about 2% of total annual power consumed in the province. Given that a typical wind turbine is capable of producing power for two average households, a total of 20,000 such turbines would therefore be able to provide “green” power for about 40,000 average households.

Furthermore, it should be. understood that while the power generated by these wind turbines is typically stepped up to higher voltages for merging into high-voltage transmission lines, there may also be applications where the voltage generated by the wind turbine needs to be stepped down. This may be the case if a small wind turbine is mounted to a low-voltage roadside tower.

The embodiments of the invention described above are therefore intended to be exemplary only. The scope of the invention is intended to be limited solely by the scope of the appended claims.

1. A power transmission tower with a wind turbine mounted thereto, the tower comprising:
a generally vertical structure having a base anchored to the ground and a plurality of supporting arms for supporting power lines that transmit electrical power; and
a wind turbine having a rotor for driving a generator, the generator being connected to an upper portion of the transmission tower.

2. The tower as claimed in claim 1 wherein the structure is selected from the group consisting of lattice structures, monopole structures and hybrid structures.

3. The tower claimed in claim 2 further comprising at least one guy wire for stabilizing the tower, the at least one guy wire being connected at an upper end to the structure and at a lower end to the ground.

4. The tower as claimed in claim 1 wherein the wind turbine is a fixed-axis turbine.

5. The tower as claimed in claim 4 wherein the wind turbine has a fixed horizontal axis.

6. The tower as claimed in claim 4 wherein the wind turbine has a fixed vertical axis.

7. The tower as claimed in claim 1 wherein the wind turbine is a variable-axis turbine.

8. The tower as claimed in claim 1 further comprising a transformer for transforming a voltage output from the generator of the wind turbine into a different voltage for feeding into one of the power lines.

9. The tower as claimed in claim 1 further comprising a power inverter.

10. A power transmission tower supporting one or more wind turbines, the tower comprising:
a tower structure having a base anchored to the ground and supporting arms for supporting power lines for transmitting electrical power; and
at least one non-vertical-axis wind turbine connected to the transmission tower for generating electrical power for feeding into a power grid serviced by the tower.

11. The tower as claimed in claim 10 wherein the non-vertical-axis wind turbine has a fixed horizontal axis.

12. The tower as claimed in claim 10 wherein the non-vertical-axis wind turbine has a variable axis permitting a rotor of the wind turbine to tilt from a horizontal-axis posture to an oblique-axis posture.

13. The tower as claimed in claim 10 wherein the tower structure is selected from the group consisting of lattice structures, monopole structures and hybrid structures.

14. The tower as claimed in claim 13 further comprising at least one guy wire for stabilizing the tower
structure, the at least one guy wire being connected at an upper end to the tower structure and at a lower end to the ground.

15. The tower as claimed in claim 10 further comprising a transformer for transforming a voltage output from the generator of the wind turbine into a different voltage for feeding into one of the power lines.

16. The tower as claimed in claim 10 further comprising a power inverter.

17. A wind turbine kit for mounting a wind turbine to a power transmission tower, the kit comprising:
a non-vertical-axis wind turbine having a rotor for driving a generator; and
a connector for connecting the wind turbine to the tower.

18. The wind turbine kit as claimed in claim 17 wherein the non-vertical-axis wind turbine is a fixed horizontal-axis wind turbine.

19. The wind turbine kit as claimed in claim 17 wherein the non-vertical-axis wind turbine is a variable-axis wind turbine capable of tilting between a horizontal-axis posture and an oblique-axis posture.

20. The wind turbine kit as claimed in claim 17 further comprising at least one accessory selected from the group consisting of transformers and power inverters.
